(19) United States
(12) Patent Application Publication
(10) Pub. No.: US 2025/0045039 A1
(43) Pub. Date: Feb. 6, 2025

(54) PROGRAM GENERATION DEVICE, PROGRAM GENERATION METHOD, AND COMPUTER READABLE MEDIUM

(71) Applicant: Mitsubishi Electric Corporation, Tokyo (JP)

(72) Inventors: Takaaki ABE, Tokyo (JP); Satoshi NOGUCHI, Tokyo (JP)

(73) Assignee: Mitsubishi Electric Corporation, Tokyo (JP)

(21) Appl. No.: 18/927,717

(22) Filed: Oct. 25, 2024

Related U.S. Application Data
(63) Continuation of application No. PCT/JP2022/024781, filed on Jun. 21, 2022.

(51) Int. Cl. G06F 8/65

(52) U.S. Cl. CPC G06F 8/65

(57) ABSTRACT

A changed part identification unit (27) compares original data that is design data (41) before being changed with changed data is the design data (41) after being changed in terms of each piece of design information that is a constituent of each of the original data and the changed data. The changed part identification unit (27) thus identifies a changed part in a control program (51) generated from the original data. A change reflection unit (28) updates the control program (51) by setting a new program component generated from the changed data for the changed part identified by the changed part identification unit (27).

### CROSS REFERENCE TO RELATED APPLICATION

This application is a Continuation of PCT International Application No. PCT/JP2022/024781, filed on Jun. 21, 2022, which is hereby expressly incorporated by reference into the present application.

### TECHNICAL FIELD

The present disclosure relates to a technology to automatically generate a program from design data.

### BACKGROUND ART

Various devices are used in the manufacturing industry and so on. Device manufacturers develop control programs to realize control of devices. Developing a control program requires many man-hours. Therefore, in order to make this development more efficient, technologies to generate a control program from design data are being developed.

Patent Literature 1 describes a technology to generate a ladder program, which is a type of control program, based on a time chart that is design data of a device to be controlled. The ladder program is a program of a relay circuit type that combines an input device, an output device, an internal device, and so on. The input device indicates a memory address where the value of an input signal is stored. The output device indicates a memory address where an output signal is stored. The internal device indicates a memory address where a result of processing by the program or the like is stored.

### CITATION LIST

### Patent Literature

Patent Literature 1: JP 2021-149853 A

### SUMMARY OF INVENTION

### Technical Problem

With a technology to generate a control program from design data, it is difficult to generate the entire program. Therefore, in many cases, users add processes to generated control programs. The added processes are a process to link with an external device, an error process, a process to return to the home position, and so on.

After the user has added a process to the control program, rework may occur due to a change in the design of a device, for example. In this case, the control program is regenerated from the changed design data, and the user adds the process to the regenerated control program again. Alternatively, the user identifies the scope of impact of the design change on the control program and modifies the control program without regenerating the control program. In either case, a lot of work is involved.

When the control program is regenerated from the changed design data, the internal device number or the like assigned to a program component corresponding to a part with no change in the design may be changed due to the impact of a part where the design has been changed. The change in the internal device number or the like will also affect a process that is added by the user and is linked to the part of the program with no change in the design. Therefore, when the user adds a process to the regenerated control program, it is necessary to carefully check the presence or absence of impact.

An object of the present disclosure is to make it possible to simplify work to generate a control program from design data changed after a process is added to a control program.

### Solution to Problem

A program generation device according to the present disclosure includes
a changed part identification unit to identify a changed part in a control program generated from original data by comparing the original data with changed data in terms of each piece of design information that is a constituent of each of the original data and the changed data, the original data being design data before being changed, the changed data being the design data after being changed; and
a change reflection unit to update the control program by setting a new program component generated from the changed data for the changed part identified by the changed part identification unit.

### Advantageous Effects of Invention

In the present disclosure, original data and changed data are compared in terms of design information so as to identify a changed part in a control program. Then, the control program is updated by setting a new program component generated from the changed data for the changed part.

This allows the control program to be updated without affecting program components corresponding to unchanged parts in design data. As a result, it is possible to simplify work to generate a control program from design data changed after a process is added to a control program.

### BRIEF DESCRIPTION OF DRAWINGS

FIG. 1 is a configuration diagram of a program generation device 10 according to Embodiment 1;

FIG. 2 is a figure describing design data 41 according to Embodiment 1;

FIG. 3 is a flowchart of an initial generation process according to Embodiment 1;

FIG. 4 is a figure describing a list of tracking information 53 according to Embodiment 1;

FIG. 5 is a figure describing a program component 52 according to Embodiment 1;

FIG. 6 is a figure describing a control program 51 according to Embodiment 1;

FIG. 7 is a flowchart of a regeneration process according to Embodiment 1;

FIG. 8 is a figure describing the control program 51 with an addition by a user according to Embodiment 1;

FIG. 9 is a figure describing original data 42 and changed data 43 according to Embodiment 1;

FIG. 10 is a figure describing a changed part identification process according to Embodiment 1;

FIG. 11 is a figure describing the control program 51 that has been updated according to Embodiment 1;

FIG. 12 is a configuration diagram of the program generation device 10 according to Variation 2;

FIG. 13 is a configuration diagram of the program generation device 10 according to Embodiment 2;

FIG. 14 is a figure describing a 3D simulator according to Embodiment 2;

FIG. 15 is a figure describing an action condition setting created using a high-level language according to Embodiment 2;

FIG. 16 is a flowchart of the initial generation process according to Embodiment 2;

FIG. 17 is a figure describing link data 45 according to Embodiment 2; and

FIG. 18 is a flowchart of the regeneration process according to Embodiment 2.

### DESCRIPTION OF EMBODIMENTS

### Embodiment 1

### ***Description of Configuration***

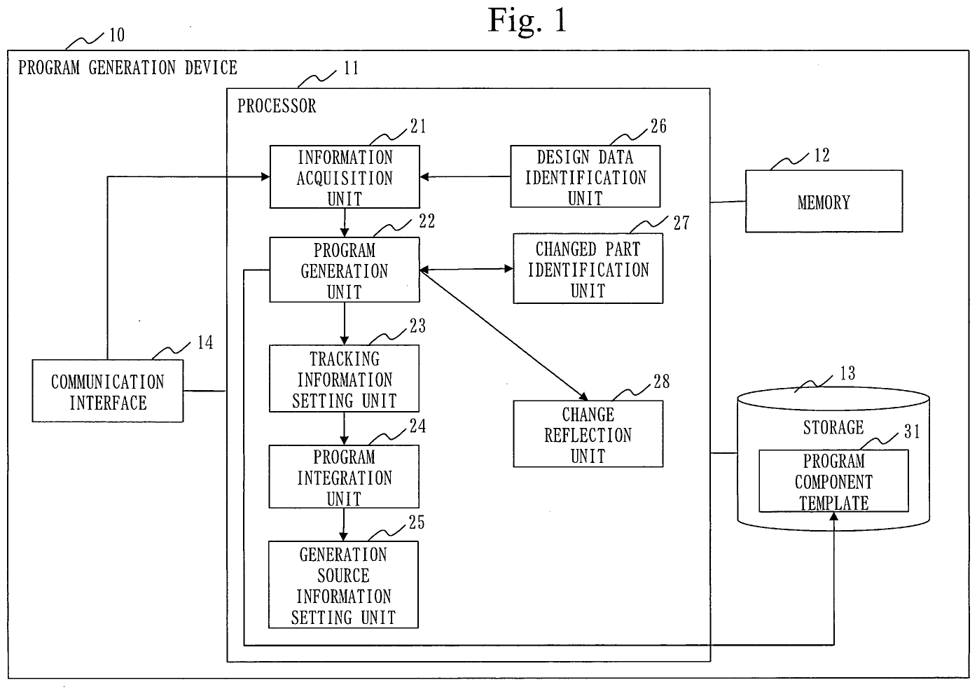

Referring to FIG. 1, a configuration of a program generation device 10 according to Embodiment 1 will be described.

The program generation device 10 is a computer.

The program generation device 10 includes hardware of a processor 11, a memory 12, a storage 13, and a communication interface 14. The processor 11 is connected with other hardware components through signal lines and controls these other hardware components.

The processor 11 is an IC that performs processing. IC is an abbreviation for integrated circuit. Specific examples of the processor 11 are a CPU, a DSP, and a GPU. CPU is an abbreviation for central processing unit. DSP is an abbreviation for digital signal processor. GPU is an abbreviation for graphics processing unit.

The memory 12 is a storage device to temporarily store data. Specific examples of the memory 12 are an SRAM and a DRAM. SRAM is an abbreviation for static random access memory. DRAM is an abbreviation for dynamic random access memory.

The storage 13 is a storage device to store data. A specific example of the storage 13 is an HDD. HDD is an abbreviation for hard disk drive. Alternatively, the storage 13 may be a portable recording medium such as an SD (registered trademark) memory card, CompactFlash (registered trademark), a NAND flash, a flexible disk, an optical disc, a compact disc, a Blu-ray (registered trademark) disc, or a DVD. SD is an abbreviation for Secure Digital. DVD is an abbreviation for digital versatile disk.

The communication interface 14 is an interface for communicating with other devices. Specific examples of the communication interface 14 are an Ethernet (registered trademark) port, a USB port, and an HDMI (registered trademark) port. USB is an abbreviation for Universal Serial Bus. HDMI is an abbreviation for High-Definition Multimedia Interface.

The program generation device 10 includes, as functional components, an information acquisition unit 21, a program generation unit 22, a tracking information setting unit 23, a program integration unit 24, a generation source information setting unit 25, a design data identification unit 26, a changed part identification unit 27, and a change reflection unit 28. The functions of the functional components of the program generation device 10 are realized by software.

The storage 13 stores programs that realize the functions of the functional components of the program generation device 10. These programs are read into the memory 12 by the processor 11 and executed by the processor 11. This realizes the functions of the functional components of the program generation device 10.

The storage 13 stores program component templates 31.

In FIG. 1, only one processor 11 is illustrated. However, there may be a plurality of processors 11, and the plurality of processors 11 may cooperate to execute the programs that realize the functions.

### ***Description of Operation***

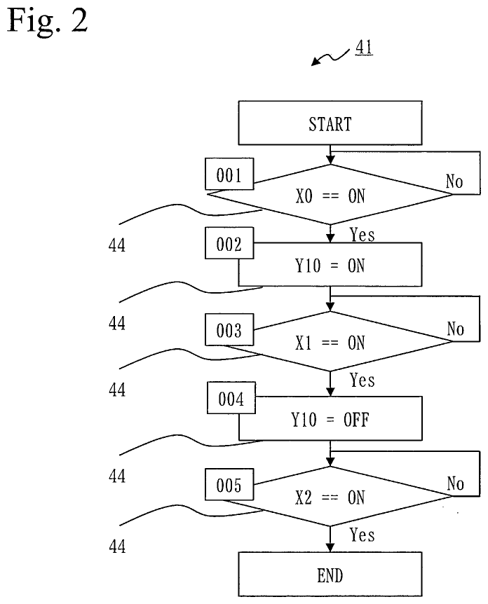

Referring to FIGS. 2 to 11, operation of the program generation device 10 according to Embodiment 1 will be described.

A procedure for the operation of the program generation device 10 according to Embodiment 1 is equivalent to a program generation method according to Embodiment 1. A program that realizes the operation of the program generation device 10 according to Embodiment 1 is equivalent to a program generation program according to Embodiment 1.

The operation of the program generation device 10 includes an initial generation process and a regeneration process. The initial generation process is a process that takes, as input, design data 41 and generates a control program 51. The regeneration process is a process that takes, as input, original data 42 that is the design data 41 before being changed, changed data 43 that is the design data 41 after being changed, and the control program 51 corresponding to the original data 42, and updates the control program 51.

For example, the program generation device 10 displays a button representing the initial generation process and a button representing the regeneration process on a display device. Then, when the button representing the initial generation process is pressed, the program generation device 10 executes the initial generation process. When the button representing the regeneration process is pressed, the program generation device 10 executes the regeneration process.

Referring to FIG. 2, an example of the design data 41 according to Embodiment 1 will be described.

The design data 41 indicated in FIG. 2 represents the following process. When X0 is turned ON, Y10 is turned ON. When X1 is turned ON, Y10 is turned OFF. Then, when X2 is turned ON, the process ends. A variable beginning with X represents an input signal to a control device. A variable beginning with Y represents an output signal from the control device.

For individual pieces of design information 44 that are elements of the design data 41, IDs from 001 to 005 are respectively set. ID is an abbreviation for identifier. The ID is used to compare the design data 41 before being changed with the design data 41 after being changed. That is, the ID is used to compare the original data 42 with the changed data 43. For example, by comparing pieces of the design information 44 with the same ID, whether or not this design information 44 has been changed is determined. The design information 44 that does not exist in the original data 42 but exists in the changed data 43 is identified as the design information 44 that has been newly added. Conversely, the design information 44 that does not exist in the changed data 43 but exists in the original data 42 is identified as the design information 44 that has been deleted.

The format of the design data 41 may be different from the format indicated in FIG. 2, provided that it is a format that allows pieces of the design information 44 before and after being changed to be compared.

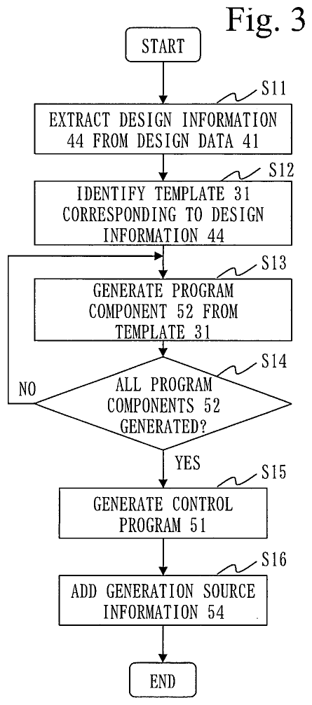

Referring to FIG. 3, the initial generation process according to Embodiment 1 will be described.

### (Step S11: Information Acquisition Process)

The information acquisition unit 21 extracts information required to generate a control program 51 from design data 41.

Specifically, when the initial generation process button is pressed, the information acquisition unit 21 prompts the user to specify the design data 41 to be used as input. The information acquisition unit 21 acquires the specified design data 41. The information acquisition unit 21 acquires each piece of design information 44 included in the design data 41.

### (Step S12: Component Identification Process)

The program generation unit 22 sets each piece of the design information 44 acquired in step S11 as target design information 44. The program generation unit 22 classifies the target design information 44, and identifies a program component template 31 corresponding to this information. For example, the program generation unit 22 classifies the target design information 44 according to its structure or the like, such as whether it has a conditional branch structure or a repeat structure. The program generation unit 22 may classify the target design information 44 based on its content. The program component template 31 is a basis for a program component 52 corresponding to the design information 44.

At this time, the tracking information setting unit 23 sets tracking information 53 for associating the design information 44 with the program component 52. The tracking information setting unit 23 sets a unique value for each program component 52 as the tracking information 53.

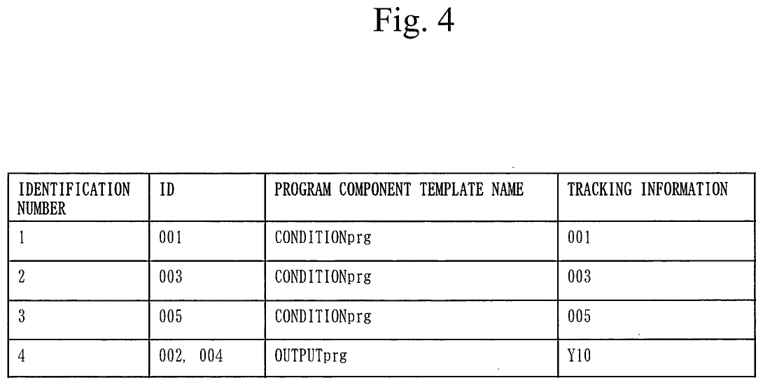

The tracking information setting unit 23 generates a list of the tracking information 53, as indicated in FIG. 4. The list of the tracking information 53 includes an ID, a name of the program component template 31, and the tracking information 53 for each identification number.

There may be a case where one program component 52 is generated from one piece of the design information 44. In this case, the value of the ID is directly set as the tracking information 53, as in the record of the identification number “1”. There may also be a case where a plurality of pieces of the design information 44 are used together to generate one program component 52. In this case, information that is common to the plurality of pieces of the design information 44 is set as the tracking information 53, as in the record of the identification number “4”. In the record of the identification number “4”, Y10 is set as the tracking information 53 because a variable “Y10” is common to the design information 44 of ID “002” and ID “003”. In what case a plurality pieces of the design information 44 are grouped together to generate one program component 52 is set in advance. For example, when a plurality of pieces of the design information 44 have a specific structure and use the same variable, they may be grouped together to generate one program component 52.

The information that is set as the tracking information 53 is not limited to the above. For example, the information that is set as the tracking information 53 may be information such as a combination of information included in the design information 44 and the name of the program component template 31.

### (Step S13: Program Generation Process)

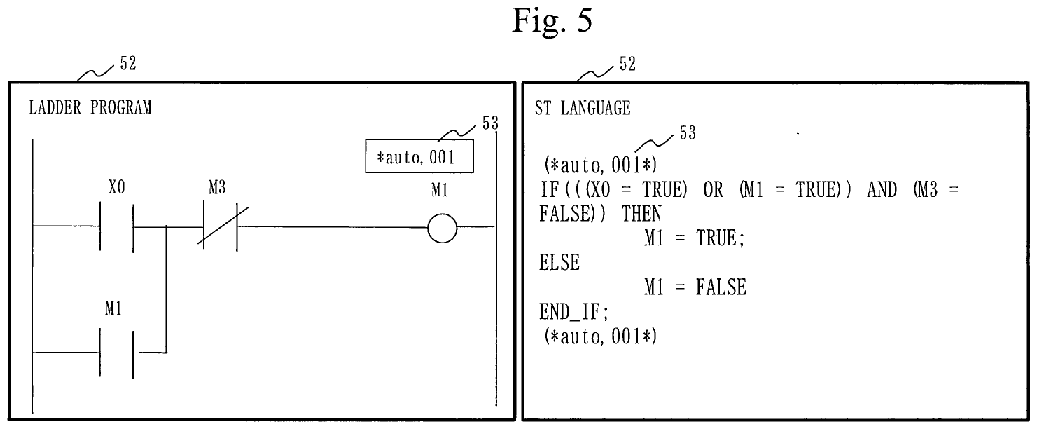

The program generation unit 22 sets, as a target record, a record that has not been processed among the records in the list of the tracking information 53 generated in step S12. The program generation unit 22 sets information from the design information 44 corresponding to the target record in the program component template 31 of the target record. Specifically, the program generation unit 22 sets a variable name in the target design information 44 as a variable name in the program component template 31. The program generation unit 22 thus generates the program component 52 corresponding to the target design information 44, as indicated in FIG. 5. In FIG. 5, a case where the program component 52 is a ladder program and a case where the program component 52 is written in the ST language are indicated. ST is an abbreviation for structured text.

At this time, the tracking information setting unit 23 adds a corresponding piece of the tracking information 53 to the program component 52. For example, the tracking information setting unit 23 adds the tracking information 53 to the program component 52 using the comment function of the programming language. Alternatively, the tracking information setting unit 23 may add, to the program component 52, information indicating that it is generated by the program generation device 10. In FIG. 5, “auto” is added as the information indicating that it is generated by the program generation device 10.

### (Step S14: Termination Determination Process)

The program generation unit 22 determines whether all the program components 52 have been generated. Specifically, the program generation unit 22 determines whether all the records in the list of the tracking information 53 have been processed. If all the records have been processed, the program generation unit 22 determines that all the program components 52 have been generated.

If all the program components 52 have been generated, the program generation unit 22 advances processing to step S15. If there is any program component 52 that has not been generated, the program generation unit 22 returns processing to step S13.

### (Step S15: Program Integration Process)

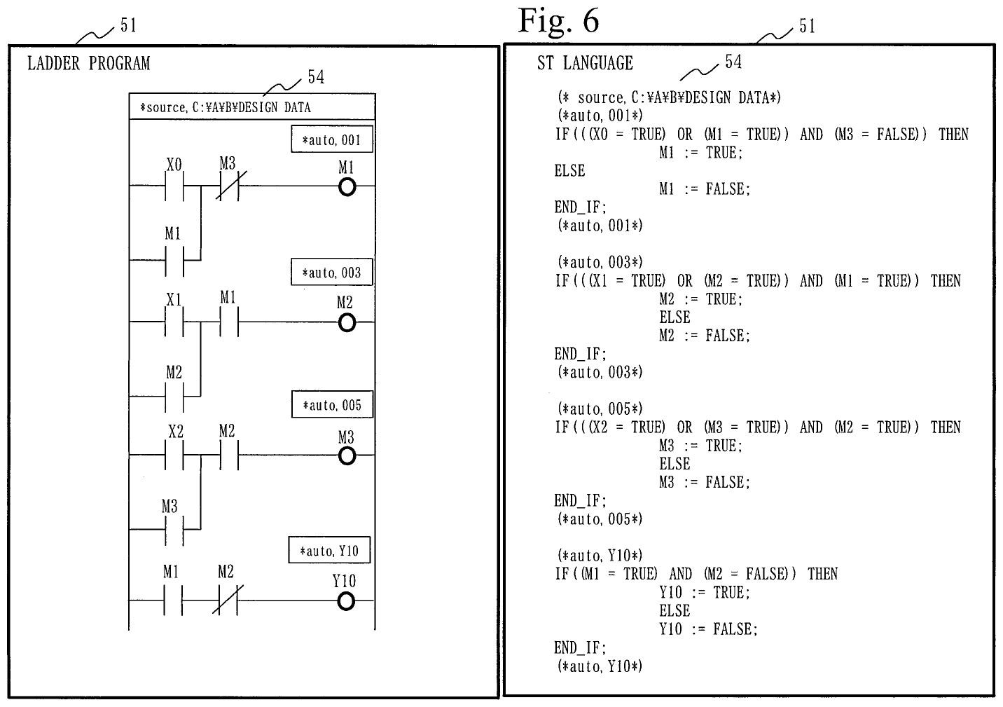

As indicated in FIG. 6, the program integration unit 24 generates the control program 51 by arranging the program components 52 generated in step S13 in the order indicated by the design data 41.

### (Step S16: Generation Source Information Setting Process)

The generation source information setting unit 25 adds generation source information 54 that indicates the design data 41 that is a generation source to the control program 51 generated in step S15. For example, the generation source information setting unit 25 uses the comment function of the programming language to add the generation source information 54 to the control program 51. The generation source information 54 is, for example, a file path of the design data 41. In FIG. 6, a character string “source, C:¥A¥B¥design data” is the generation source information 54.

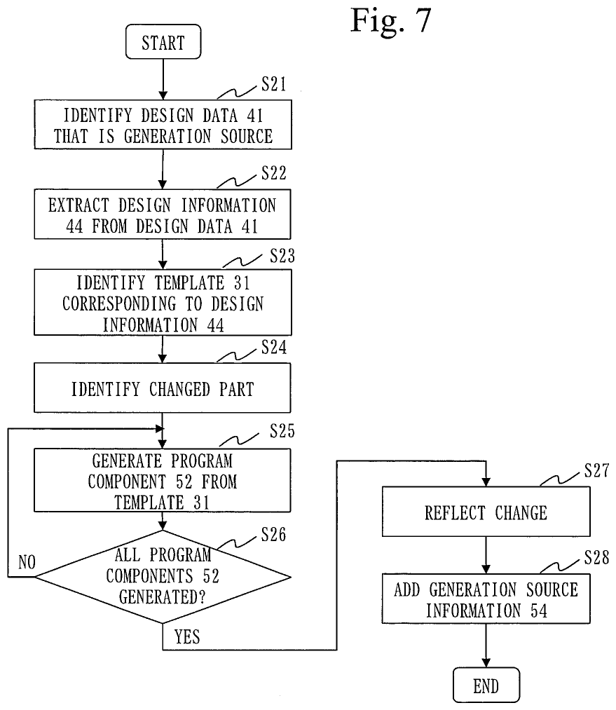

Referring to FIG. 7, the regeneration process according to Embodiment 1 will be described.

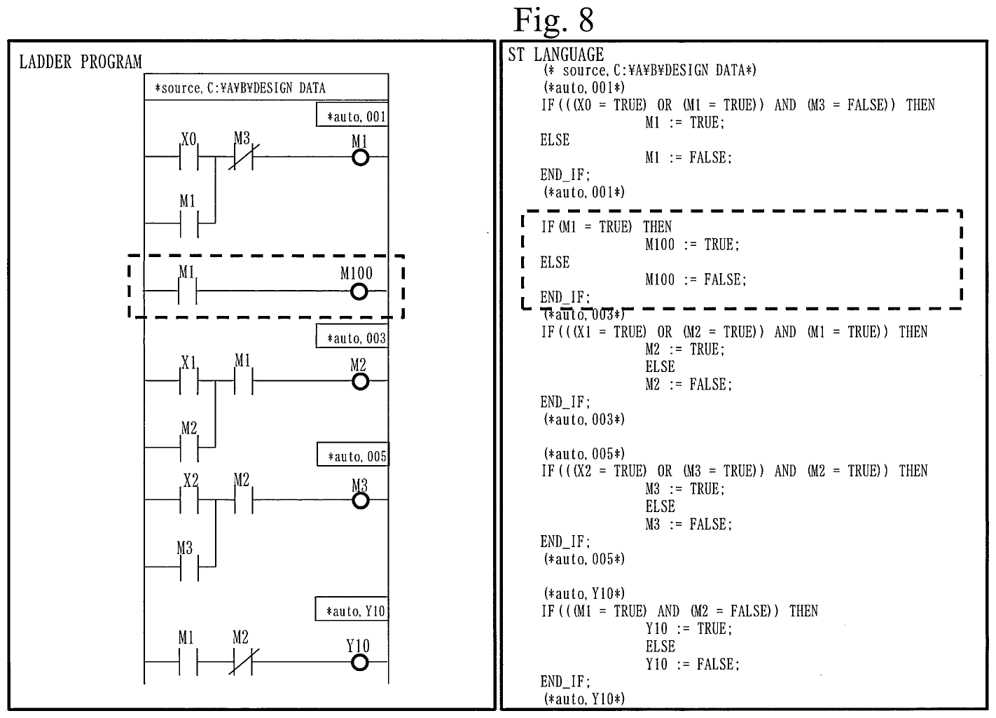

As indicated in FIG. 8, it is assumed here that the user has added a process to the control program 51 generated in the initial generation process, as indicated by the part enclosed by dashed lines.

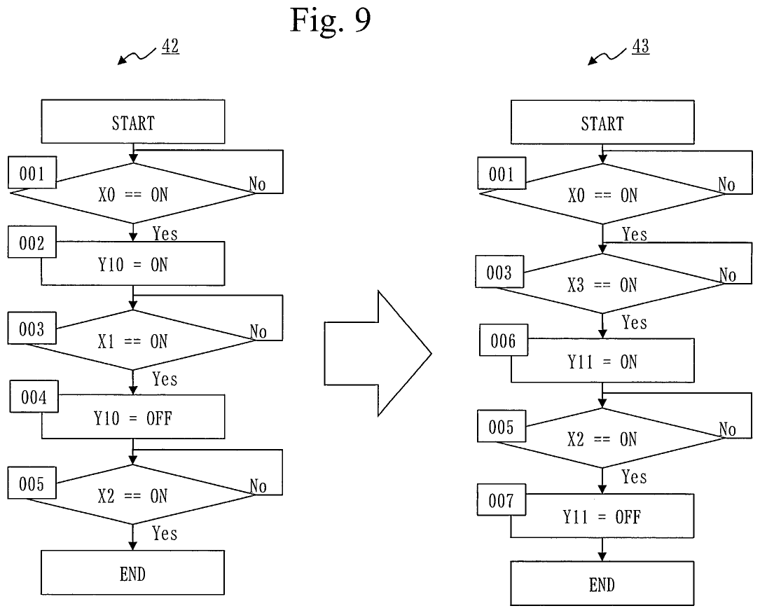

It is also assumed that the original data 42 has been changed to the changed data 43, as indicated in FIG. 9. The original data 42 is the same as the design data 41 indicated in FIG. 2.

### (Step S21: Design Data Identification Process)

The design data identification unit 26 identifies the design data 41 that is a generation source from the control program 51.

Specifically, when the regeneration process button is pressed, the design data identification unit 26 prompts the user to specify the control program 51 and the changed data 43 that are to be used as input. The design data identification unit 26 acquires the control program 51 and the changed data 43 that have been specified. The design data identification unit 26 identifies the original data 42 that is the design data 41 of the generation source based on the generation source information 54 included in the control program 51.

The original data 42 is the design data 41 used when the control program 51 is generated. The changed data 43 is the design data 41 obtained by changing the original data 42. The changed data 43 is the design data 41 based on which the control program 51 is to be regenerated.

### (Step S22: Information Acquisition Process)

The information acquisition unit 21 performs the same process as that of step S11 in FIG. 3, using the original data 42 and the changed data 43 as the target design data 41.

### (Step S23: Component Identification Process)

The program generation unit 22 performs the same process as that of step S12 in FIG. 3, using the original data 42 and the changed data 43 as the target design data 41.

### (Step S24: Changed Part Identification Process)

The changed part identification unit 27 sets each piece of the design information 44 included in each of the original data 42 and the changed data 43 as the target design information 44. The changed part identification unit 27 compares the original data 42 with the changed data 43 in terms of the target design information 44. The changed part identification unit 27 thus identifies a part in which a change has been made to the control program 51.

Here, the changed part identification unit 27 identifies whether each piece of the design information 44 is updated information, non-updated information, deleted information, or added information. Updated information is the design information 44 in which there is a difference between the original data 42 and the changed data 43. Non-updated information is the design information 44 in which there is no difference between the original data 42 and the changed data 43. Deleted information is the design information 44 that does not exist in the changed data 43 but exists in the original data 42. Added information is the design information 44 that does not exist in the original data 42 but exists in the changed data 43.

Then, the changed part identification unit 27 identifies updated information, deleted information, and added information as changed parts.

Specifically, the changed part identification unit 27 sets, as the target record, each record in the list of the tracking information 53 for each of the original data 42 and the changed data 43 generated in step S23. Note that with regard to records in which the same ID is set between the list of the tracking information 53 for the original data 42 and the list of the tracking information 53 for the changed data 43, the changed part identification unit 27 sets only one of the records as the target record.

The changed part identification unit 27 compares the design information 44 of the target record with a corresponding piece of the design information 44. When the target record is a record in the list of the tracking information 53 for the original data 42, the corresponding piece of the design information 44 is the design information 44 in the changed data 43 in which the same tracking information 53 as that in the design information 44 of the target record is set. When the target record is a record in the list of the tracking information 53 for the changed data 43, the corresponding piece of the design information 44 is the design information 44 in the original data 42 in which the same tracking information 53 as that in the design information 44 of the target record is set. Then, the changed part identification unit 27 identifies whether the design information 44 of the target record is updated information, non-updated information, deleted information, or added information.

It is assumed that the target record is a record in the list of the tracking information 53 for the original data 42. In this case, if a record with the tracking information 53 in the target record is included in the list of the tracking information 53 generated for the changed data 43 and a change has been made to the design information 44, it is updated information. In this case, if a record with the tracking information 53 in the target record is included in the list of the tracking information 53 generated for the changed data 43 and no change has been made to the design information 44, it is non-updated information. In this case, if a record with the tracking information 53 in the target record is not included in the list of the tracking information 53 generated for the changed data 43, it is deleted information. It is assumed that the target record is a record in the list of the tracking information 53 for the changed data 43. In this case, if a record with the tracking information 53 in the target record is not included in the list of the tracking information 53 generated for the original data 42, it is added information.

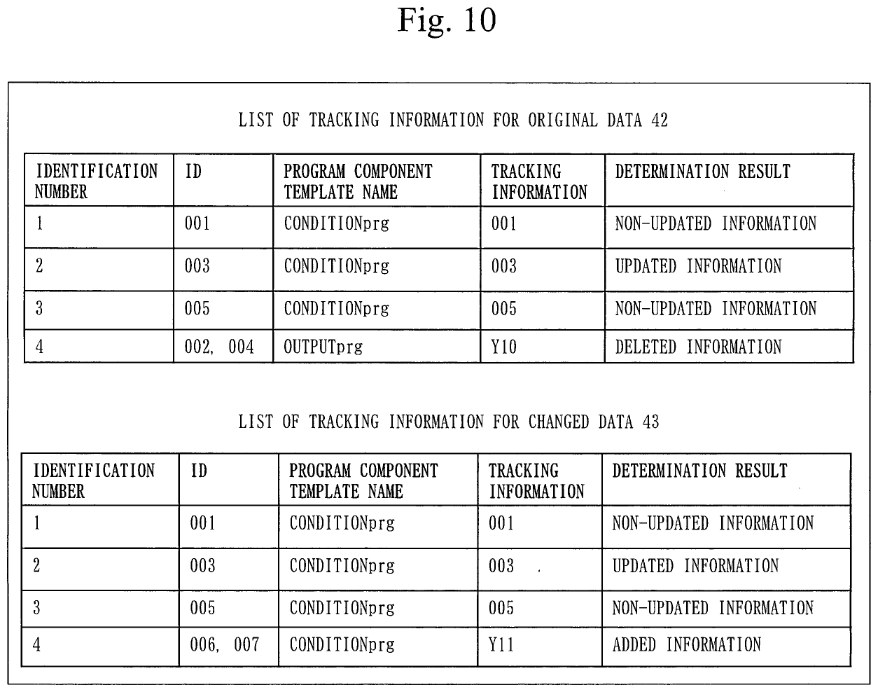

When the changed part identification process is performed on the original data 42 and the changed data 43 indicated in FIG. 9, the result is as indicated in FIG. 10. The design information 44 of ID “003” is updated information. The design information 44 of ID “001” and ID “005” is non-updated information. The design information 44 of ID “002” and ID “003” is deleted information. The design information 44 of ID “004” and ID “006” is added information.

### (Step S25: Program Generation Process)

The program generation unit 22 generates a new program component 52 for each piece of the design information 44 determined as updated information or added information in step S24.

Specifically, the program generation unit 22 sets, as the target record, a record that has been determined as updated information or added information and has not been processed among the records in the list of the tracking information 53 generated for the changed data 43. The program generation unit 22 sets information from the design information 44 corresponding to the target record in the program component template 31 of the target record, as in step S13 in FIG. 3. The program generation unit 22 thus generates the program component 52 corresponding to the target design information 44. At this time, when a record determined as updated information is the target record, the program generation unit 22 may generate a new program component 52 by reusing the internal device used when the existing control program 51 is generated. This makes it possible to prevent the internal device number from being changed and reduce the impact on other programs generated by the program generation device 10 and programs added by users.

The tracking information setting unit 23 adds the corresponding piece of the tracking information 53 to the program component 52, as in step S13 in FIG. 3. The tracking information setting unit 23 may add, to the program component 52, information indicating that it is generated by the program generation device 10.

### (Step S26: Termination Determination Process)

The program generation unit 22 determines whether the program components 52 have been generated for all the pieces of the design information 44 determined as updated information or added information.

If all the program components 52 have been generated, the program generation unit 22 advances processing to step S27. If there is any program component 52 that has not been generated, the program generation unit 22 returns processing to step S25.

### (Step S27: Change Reflection Process)

The change reflection unit 28 sets, as the target record, each record in the list of the tracking information 53 generated for each of the original data 42 and the changed data 43 in step S23. With regard to records in which the same ID is set in the list of the tracking information 53 for the original data 42 and the list of the tracking information 53 for the changed data 43, the change reflection unit 28 sets only one of the records as the target record.

The change reflection unit 28 performs the following processing to update the control program 51, depending on the result determined in step S24.

### <In the Case of Updated Information>

The change reflection unit 28 uses the tracking information 53 in the target record to identify the program component 52 corresponding to the updated information in the control program 51. The change reflection unit 28 replaces the identified program component 52 with the new program component 52. The new program component 52 is the program component 52 generated for the target record in step S25.

### <In the Case of Added Information>

The change reflection unit 28 identifies the location where the added information is added based on the changed data 43. The change reflection unit 28 uses the tracking information 53 in the target record to identify the location in the control program 51 that corresponds to the identified location. The change reflection unit 28 inserts the new program component 52 into the control program 51 at the identified location. The new program component 52 is the program component 52 generated for the target record in step S25.

### <In the Case of Deleted Information>

The change reflection unit 28 uses the tracking information 53 in the target record to identify the program component 52 corresponding to the deleted information in the control program 51. The change reflection unit 28 deletes the identified program component 52 from the control program 51.

### <In the Case of Non-Updated Information>

The change reflection unit 28 retains the program component 52 corresponding to the non-updated information in the control program 51 without any change.

### (Step S28: Generation Source Information Setting Process)

The generation source information setting unit 25 adds the generation source information 54 indicating the changed data 43 used as the generation source to the control program 51 generated in step S15. For example, the generation source information setting unit 25 updates a path indicating the original data 42 to a path indicating the changed data 43.

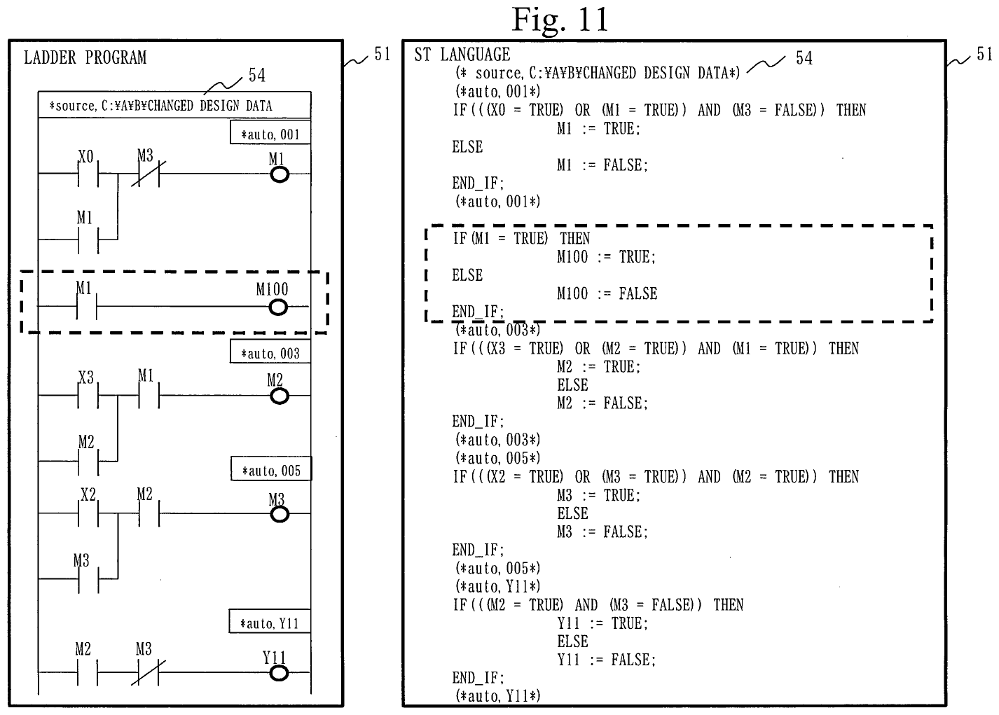

This updates the control program 51 as indicated in FIG. 11. In the updated control program 51, the process added by the user indicated in FIG. 8 remains. The process of ID “003”, which is updated information, is updated. The processes of ID “006” and ID “007”, which are added information, (the processes whose tracking information 53 is Y11) are added. The processes of ID “002” and ID “004”, which are deleted information, (the processes whose tracking information 53 is Y10) is deleted.

### ***Effects of Embodiment 1***

As described above, the program generation device 10 according to Embodiment 1 compares the original data 42 with the changed data 43 in terms of the design information 44 to identify a changed part in the control program 51. Then, the control program 51 is updated by setting a new program component 52 generated from the changed data for the changed part.

This causes only the program component 52 corresponding to the changed part in the design data 41 to be updated. Therefore, the control program 51 can be updated without affecting the program components 52 corresponding to unchanged parts in the design data 41. As a result, it is possible to simplify work to generate a control program 51 from design data 41 changed after a process is added to a control program 51.

More specifically, in the regeneration process, the program generation device 10 according to Embodiment 1 classifies each piece of the design information 44 in the original data 42 and the changed data 43 as updated information, non-updated information, deleted information, or added information. Then, the program generation device 10 performs processing according to the classification so as to update the control program 51. As a result, a process that is added by the user and does not correspond to the design information 44 remains unchanged.

This makes it possible, when a control program is generated from design data changed after a process is added to a control program, to retain the added process.

The program generation device 10 according to Embodiment 1 retains the program component 52 corresponding to a piece of the design information 44 classified as non-updated information without any change. Therefore, no change is made to the program component 52 whose design data has not been changed.

When generating the program component 52 corresponding to a piece of the design information 44 classified as updated information, the program generation device 10 according to Embodiment 1 reuses the internal device used when the existing control program 51 is generated. This can prevent the number of the internal device from being changed and reduce the impact on other program components 52.

### ***Other Configurations***

### <Variation 1>

In Embodiment 1, the control program 51 generated in the initial generation process is updated in the regeneration process. However, even the control program 51 generated by a different system can also be updated by the regeneration process, provided that this control program 51 has substantially the same structure as the control program 51 generated in the initial generation process.

### <Variation 2>

In Embodiment 1, the functional components are realized by software. However, as Variation 2, the functional components may be realized by hardware. With regard to this Variation 2, differences from Embodiment 1 will be described.

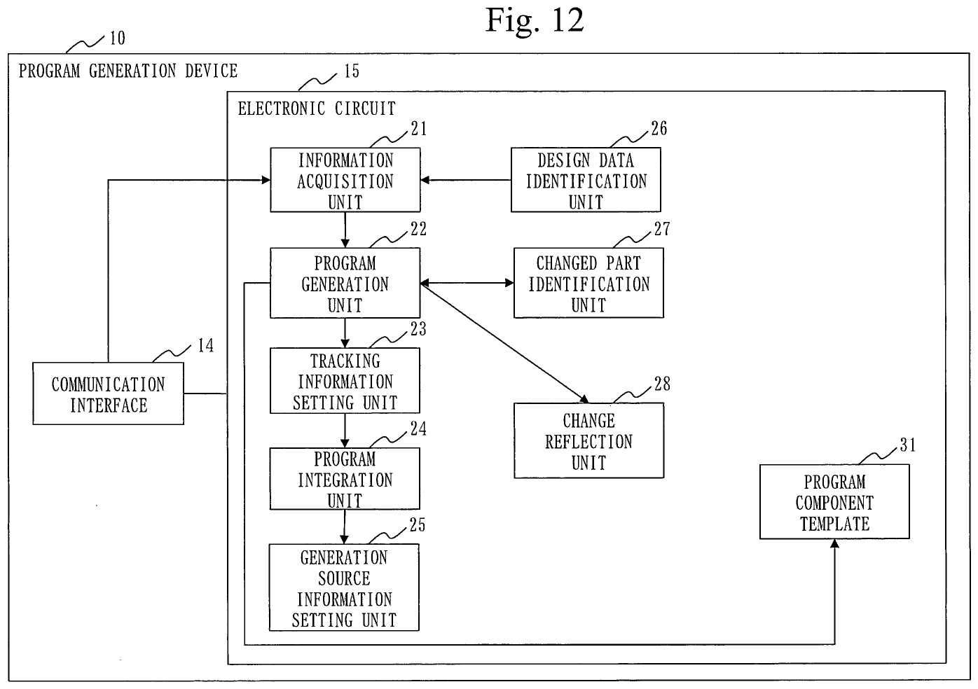

Referring to FIG. 12, a configuration of the program generation device 10 according to Variation 2 will be described.

When the functional components are realized by hardware, the program generation device 10 includes an electronic circuit 15 in place of the processor 11, the memory 12, and the storage 13. The electronic circuit 15 is a dedicated circuit that realizes the functions of the functional components, the memory 12, and the storage 13.

The electronic circuit 15 is assumed to be a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

The functional components may be realized by one electronic circuit 15, or the functional components may be distributed to and realized by a plurality of electronic circuits 15.

### <Variation 3>

As Variation 3, some of the functional components may be realized by hardware, and the rest of the functional components may be realized by software.

Each of the processor 11, the memory 12, the storage 13, and the electronic circuit 15 is referred to as processing circuitry. That is, the functions of the functional components are realized by the processing circuitry.

### Embodiment 2

In Embodiment 2, a case will be described where a control program 51 is applied to a 3D simulator used in device development. 3D is an abbreviation for three-dimensional. In Embodiment 2, differences from Embodiment 1 will be described, and description of the same aspects will be omitted.

In recent years, device manufacturers have been using 3D simulators to develop devices in order to reduce rework in device development. A 3D simulator is software that allows various verifications that would normally be performed using an actual device to be performed without using the actual device.

In order to perform verifications on devices using 3D simulators, it is necessary to control devices on the 3D simulators. Device manufacturers control the devices on the 3D simulators using developed control programs. In some cases, device manufacturers control the devices on the 3D simulators by creating control programs specifically for controlling the devices on the 3D simulators using a high-level language that can be handled by general-purpose PCs or the like. PC is an abbreviation for personal computer.

### ***Description of Configuration***

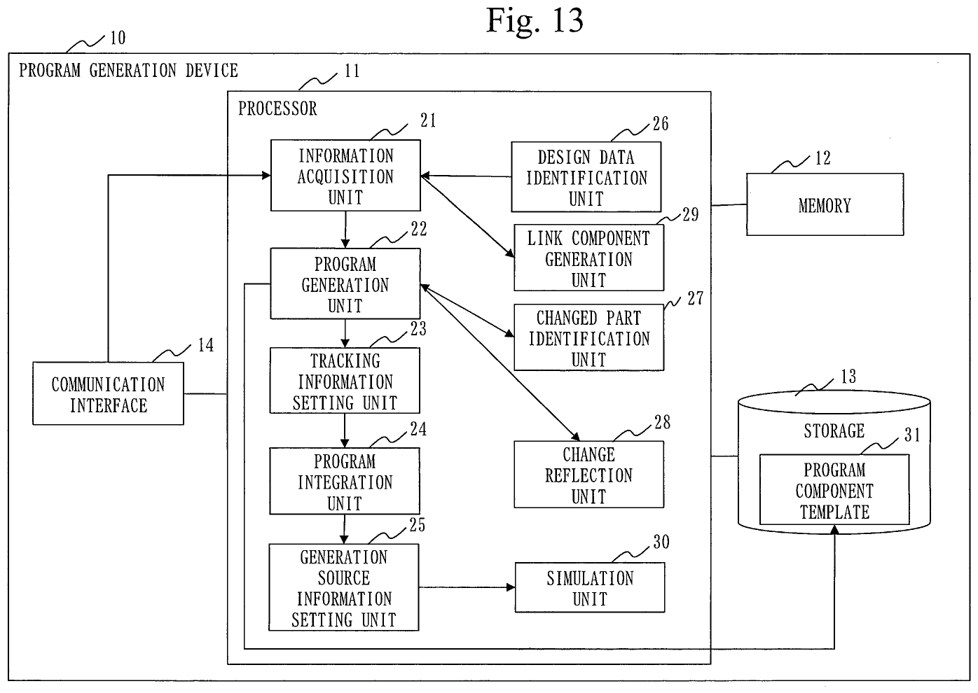

Referring to FIG. 13, a configuration of the program generation device 10 according to Embodiment 2 will be described.

The program generation device 10 differs from the program generation device 10 indicated in FIG. 1 in that a link component generation unit 29 and a simulation unit 30 are included as functional components. The functions of the link component generation unit 29 are realized by software or hardware, as with the other functional components.

In FIG. 13, the program generation device 10 includes the simulation unit 30 and realizes a 3D simulator. However, the functions of the simulation unit 30 may be included in another device. In this case, a control program 51 generated by the program generation device 10 is provided to the device that includes the simulation unit 30.

### ***Description of Operation***

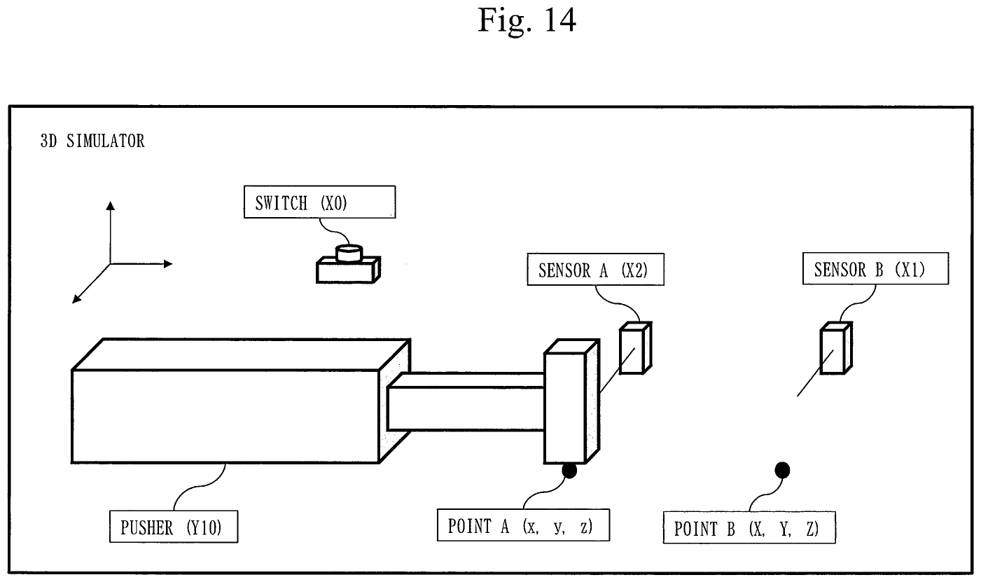

Referring to FIGS. 14 to 18, operation of the program generation device 10 according to Embodiment 2 will be described.

A procedure for the operation of the program generation device 10 according to Embodiment 2 is equivalent to the program generation method according to Embodiment 2. A program that realizes the operation of the program generation device 10 according to Embodiment 2 is equivalent to the program generation program according to Embodiment 2.

Referring to FIG. 14, an example of the 3D simulator according to Embodiment 2 will be described.

Various verifications that have been performed using an actual device are performed without the actual device by preparing a verification target device on the 3D simulator. To do this, it is necessary to set at least the following three for the verification target device on the 3D simulator: “shape setting”, “action setting”, and “action condition setting”. In FIG. 14, a pusher is indicated as the verification target device.

The shape setting is a setting that determines the shape or position of the device on the 3D simulator. For example, 3D data of the pusher designed using 3D-CAD or the like is imported into the 3D simulator. CAD is an abbreviation for computer aided design. Then, coordinates on the 3D simulator are specified. This sets the shape.

The action setting is a setting for an action of the 3D data that is set in the shape setting. For example, information such as a trigger for executing the action, a direction of movement, acceleration, and maximum speed are set. A specific example of the setting is that when a variable Y10 that is set for the pusher becomes TRUE, the tip of the pusher moves from a point A to a point B with an acceleration a and a maximum speed b.

The action condition setting is a setting for a condition for executing the action set in the action setting. For example, an action logic that rewrites the value of a variable that serves as a trigger for the action is set. A specific example of the setting is that when X0 becomes TRUE, Y10 is set to TRUE, and when X1 becomes TRUE, Y10 is set to FALSE.

That is, the action condition setting is equivalent to the control program 51. A verification may be performed by using the 3D simulator in conjunction with a control device in which the control program 51 presented in Embodiment 1 is embedded as the action condition setting. A verification may also be performed by creating a program equivalent to the control program 51 using a high-level language that can be used on a general-purpose PC or a language unique to the 3D simulator.

In the latter case, by creating a program using an API or the like of the 3D simulator, the program can be operated in conjunction with the 3D simulator. API is an abbreviation for application programming interface. The latter program is also equivalent to the control program 51, so that it can be generated by the same method as the method presented in Embodiment 1. In the latter program, a result of calculation by the 3D simulator, a simulation time, or the like can be obtained using the API of the 3D simulator.

Therefore, in order to output obtained information and use it for a verification, a process may be added to a part other than the part responsible for control. In the method presented in Embodiment 1, even if the control program 51 includes such a process added by the user, an “action condition setting” according to changed design can be regenerated while retaining the added process.

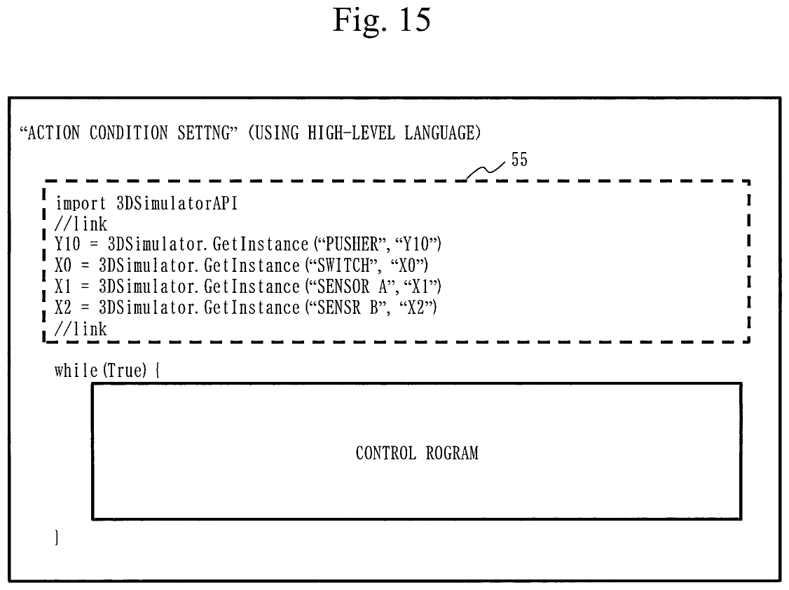

Referring to FIG. 15, an example of the action condition setting created using a high-level language according to Embodiment 2 will be described.

In the action condition setting, the part enclosed by dashed lines in FIG. 15 is set to allow a variable that is set in a model or the like on the 3D simulator to be read from and written to using the API of the 3D simulator or the like. The part enclosed by dashed lines is called a link component 55.

For example, the API is used with the 3D model name “pusher” and the variable name “Y10” set for the 3D model as arguments. This allows a value to be read from and written to the variable set in the 3D model through the action condition setting. The device on the 3D simulator is controlled by reading from and writing to this variable in the part of the control program in FIG. 15. This part of the control program may be equivalent to the program in the ST language in FIG. 6.

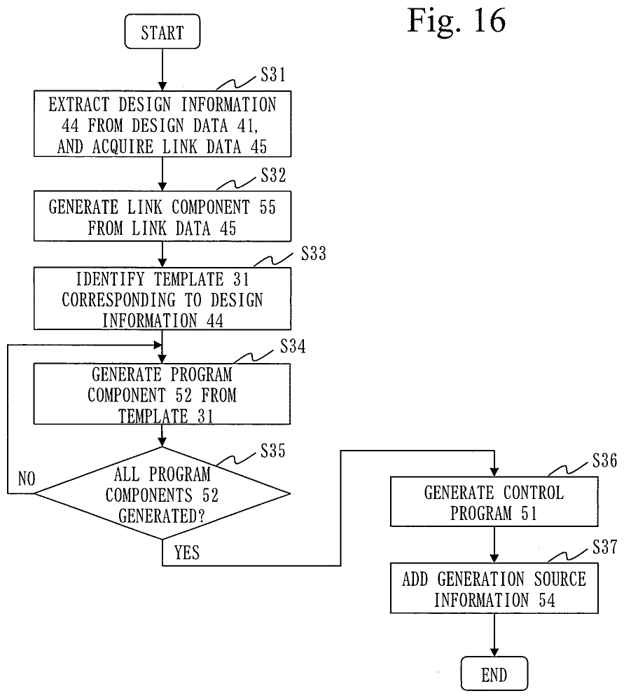

Referring to FIG. 16, the initial generation process according to Embodiment 2 will be described.

The processes of steps S33 to S37 are the same as the processes of steps S12 to S16 in FIG. 3.

### (Step S31: Information Acquisition Process)

The information acquisition unit 21 extracts information required for generating a control program 51 from design data 41, as in step S11 in FIG. 3.

At this time, the information acquisition unit 21 acquires link data 45 that indicates correspondences between variables in a 3D model in a simulator in which the control program 51 is implemented and signals in the design data 41. Specifically, the information acquisition unit 21 prompts the user to specify the link data 45 together with the design data 41.

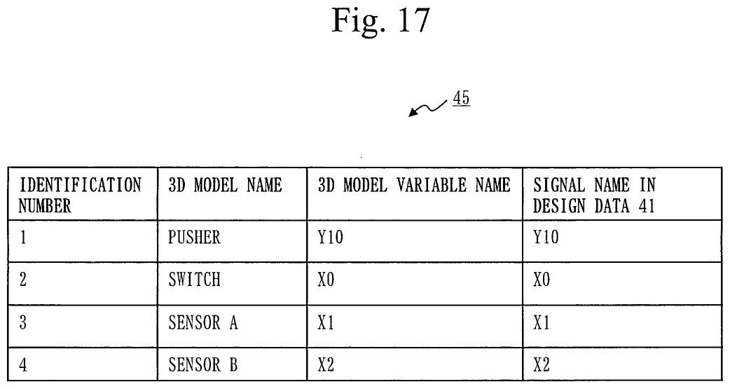

The link data 45 is data that indicates correspondences between variable names in the 3D model and signal names, as indicated in FIG. 17, for example. Associations may be made by setting up a creation rule such as that the variable names in the 3D model are the same as the signal names used in the design data 41. In this case, necessary data such as the 3D model name and variable names can be identified from the 3D simulator based on the signal names used in the design data 41. Therefore, the link data 45 does not need to be acquired.

### (Step S32: Link Component Generation Process)

The link component generation unit 29 generates a link component 55 that links the control program 51 and the 3D simulator based on the link data 45. At this time, the link component generation unit 29 may add, to the link component 55, information indicating that it is the link component 55 using the comment function of the programming language or the like. For example, a character string such as “link” is added as the information indicating that it is the link component 55.

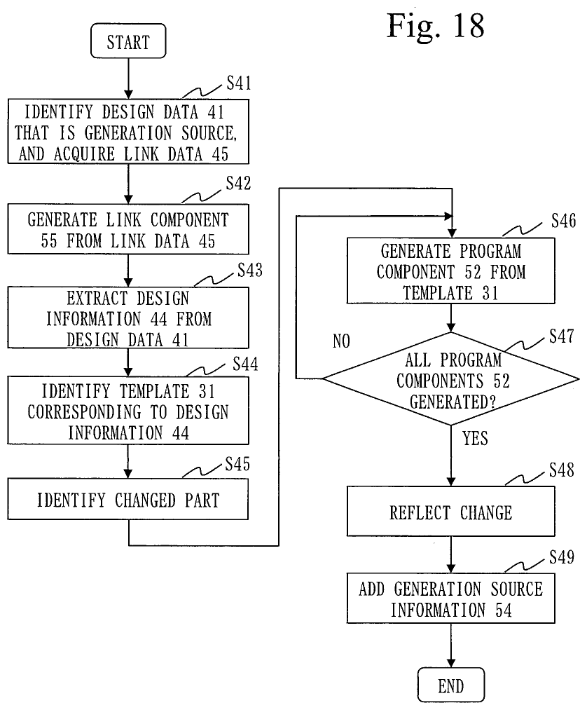

Referring to FIG. 18, the regeneration process according to Embodiment 2 will be described.

The processes of steps S43 to S49 are the same as the processes of steps S22 to S28 in FIG. 7.

### (Step S41: Design Data Identification Process)

The design data identification unit 26 identifies the design data 41 that is the generation source from the control program 51, as in step S21 in FIG. 7.

At this time, the design data identification unit 26 acquires the link data 45, as in step S31 in FIG. 16. Specifically, the design data identification unit 26 prompts the user to specify the link data 45 together with the control program 51 and so on.

### (Step S42: Link Component Generation Process)

The link component generation unit 29 generates the link component 55 based on the link data 45, as in step S22 in FIG. 7.

### ***Effects of Embodiment 2***

As described above, the program generation device 10 according to Embodiment 2 regenerates a program that realizes an action condition setting when the control program 51 is applied to a 3D simulator used in device development. At this time, a process that is added by the user is retained without any change, as described in Embodiment 1.

This makes it possible, when a program that realizes an action condition setting is generated from the design data 41 changed after a process is added to the control program 51, to retain the added program.

“Unit” in the above description may be interpreted as “circuit”, “step”, “procedure”, “process”, or “processing circuitry”.

The embodiments and variations of the present disclosure have been described above. Two or more of these embodiments and variations may be implemented in combination. Alternatively, one of them or two or more of them may be partially implemented. The present disclosure is not limited to the above embodiments and variations, and various modifications can be made as necessary.

### REFERENCE SIGNS LIST

10: program generation device, 11: processor, 12: memory, 13: storage, 14: communication interface, 15: electronic circuit, 21: information acquisition unit, 22: program generation unit, 23: tracking information setting unit, 24: program integration unit, 25: generation source information setting unit, 26: design data identification unit, 27: changed part identification unit, 28: change reflection unit, 29: link component generation unit, 30: simulation unit, 31: program component template, 41: design data, 42: original data, 43: changed data, 44: design information, 45: link data, 51: control program, 52: program component, 53: tracking information, 54: generation source information, 55: link component.

1. A program generation device comprising
processing circuitry to:
identify a changed part in a control program generated from original data by comparing the original data with changed data in terms of pieces of design information constituting each of the original data and the changed data, for each piece of design information that is a generation source of one program component, the original data being design data before being changed, the changed data being the design data after being changed; and
update the control program by setting a new program component generated from the changed data for the changed part.

2. The program generation device according to claim 1,
wherein the processing circuitry identifies each of updated information, deleted information, and added information as the changed part, the updated information being design information that differs between the original data and the changed data, the deleted information being design information that does not exist in the changed data but exists in the original data, the added information being design information that does not exist in the original data but exists in the changed data, and
wherein the processing circuitry updates the control program by setting a new program component generated from the updated information in the changed data and a new program component generated from the added information in the changed data.

3. The program generation device according to claim 2,
wherein the processing circuitry updates the control program by replacing a program component corresponding to the updated information in the control program with a new program component generated from the updated information in the changed data.

4. The program generation device according to claim 2,
wherein the processing circuitry updates the control program by inserting a new program component generated from the added information in the changed data into the control program.

5. The program generation device according to claim 2,
wherein the processing circuitry updates the control program by deleting a program component corresponding to the deleted information from the control program.

6. The program generation device according to claim 1,
wherein the processing circuitry generates a program component from the design information,
wherein the processing circuitry sets tracking information that indicates design information that is a generation source for the program component, and
wherein the design information corresponding to the program component is identified based on the tracking information.

7. The program generation device according to claim 1,
wherein generation source information that indicates design data that is a generation source is set in the control program, and
wherein the processing circuitry identifies the original data based on the generation source information that is set in the control program.

8. The program generation device according to claim 1,
wherein the processing circuitry generates a link component that links the control program and a simulator in which the control program is implemented, based on link data that indicates a correspondence between a variable in the simulator and a signal in the design data.

9. The program generation device according to claim 1,
wherein the processing circuitry acquires design data to be used as input when an initial generation process is specified, and acquires the original data and the changed data when a regeneration process is specified,
wherein the processing circuitry newly generates a control program using a program component generated from design information that is a constituent of the design data when the initial generation process is specified,
wherein the processing circuitry identifies the changed part when the regeneration process is specified, and
wherein the processing circuitry updates the control program when the regeneration process is specified.

10. A program generation method comprising:
identifying a changed part in a control program generated from original data by comparing the original data with changed data in terms of pieces of design information constituting each of the original data and the changed data, for each piece of design information that is a generation source of one program component, the original data being design data before being changed, the changed data being the design data after being changed; and
updating the control program by setting a new program component generated from the changed data for the changed part.

11. A non-transitory computer readable medium storing a program generation program that causes a computer to function as a program generation device to perform:
a changed part identification process of identifying a changed part in a control program generated from original data by comparing the original data with changed data in terms of pieces of design information constituting each of the original data and the changed data, for each piece of design information that is a generation source of one program component, the original data being design data before being changed, the changed data being the design data after being changed; and
a change reflection process of updating the control program by setting a new program component generated from the changed data for the changed part identified by the changed part identification process.
